(19) United States
(12) Patent Application Publication
(10) Pub. No.: US 2010/0036541 A1
(43) Pub. Date: Feb. 11, 2010

(54) System and Method for Monitoring Direct Load Control Units

(76) Inventors: Matthew Burkmier, Jacksonville, FL (US); Brian Kirchman, Chicago, IL (US); Marcus Ferron, Chicago, IL (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/186,223

(22) Filed: Aug. 5, 2008

(51) Int. Cl. G06F 1/28

(52) U.S. Cl. 700/297

(57) ABSTRACT

A method and system for monitoring Direct load Control Units (“DCUs”). Curtailment Monitoring Devices (“CMDs”) analyze the voltage levels of electrical appliances or networks to determine if voltage to the system has been curtailed by a DCU. The CMD will then report the data to a centralized or distributed computer system for analysis.

### BACKGROUND OF THE INVENTION

The present invention relates to a system and method for monitoring Direct load Control Units (“DCUs”). DCUs are devices that can be installed to control the amount of electricity flowing to a given application such as an electrical appliance, group of appliances, residential building, or large commercial or industrial building. Upon receiving a control signal, a given DCU will reduce or completely curtail the flow of electricity to the appliance(s) or building(s) that it controls. For instance, a DCU can be fitted to a household air conditioning unit to provide for the curtailment of service upon receiving a specified control signal. As another example, a DCU could control electricity to certain machines or areas in a factory or to the factory as a whole. In another application, a DCU could control the flow of electricity to an electrically heated swimming pool.

DCUs are generally installed in order to save energy and/or provide cost savings on energy bills. For instance, some electricity providers may provide discounted electricity rates to customers who consent to the installation of a DCU on one or more of their electric appliances. During peak demand periods for electricity, the provider can send a control signal to the DCU and curtail the flow of electricity to the customer. As another example, a large user of electricity such as a manufacturer could choose to install a DCU in order to minimize its electricity costs. Such a manufacturer could allow its electricity to be curtailed during high cost periods in order to minimize its electric bills.

Current DCUs are typically controlled via a one-way paging network such as a Motorola FLEX™ paging network. To curtail electricity use in a certain geographical region, an electricity provider (or other entity) sends out an electronic page control signal over the paging network. Such a page signals the DCUs in that geographical region to curtail the flow of electricity to the appliances under their control. Such a paging network involves one-way communication, however, and the individual DCUs will not communicate to the controlling entity whether they received the page control signal or not. Nor will the DCUs be able to communicate whether they were able to comply with the curtailment command or whether an error prevented them from doing so. Nor will the DCUs communicate any other diagnostic information such as the amount of electricity used by the appliances under their control or whether the DCU needs any maintenance.

### SUMMARY OF THE INVENTION

The present invention provides a system and method to monitor the actions and status of Direct load Control Units that have been installed in the field. In embodiments of the invention, a Curtailment Monitoring Device (“CMD”) monitors the voltage(s) of the appliance(s) that a particular DCU controls. By monitoring such voltages, the CMD can determine whether a particular DCU is actively suppressing (“curtailing”) electricity to its appliance(s) or not.

For instance, if a functioning DCU attached to an air conditioning unit receives a page control signal to suppress the electric flow to the A/C unit, the DCU responds by curtailing the electricity flow to the A/C unit. This causes a drop in voltage at the A/C unit. A CMD that is monitoring the A/C unit detects the low voltage at the A/C unit (via the CMD's integral voltmeter) and records that the DCU has successfully curtailed power to the A/C unit.

By contrast, if a non-functional DCU receives a page control signal to suppress electric flow, the DCU is unable to suppress the electric flow to the appliance it controls. Thus, the voltage to the appliance is maintained at its normal working level. A CMD that is monitoring that appliance detects that the appliance is receiving electricity at its normal operating voltage and therefore that the DCU has failed to curtail power to the appliance. Similarly, if a functioning DCU fails to receive a page control signal because of a weak paging signal, a companion CMD will be able to detect that the DCU is not curtailing electricity to the appliance.

CMDs in embodiments of the invention can communicate the status of the appliance(s) they are monitoring to a central or distributed computer system. Such communications can occur via wired or wireless communication networks. For instance, CMDs in some embodiments can communicate via cellular telephone networks, satellite, radio, Wi-Fi, or any other wireless communication network or protocol. CMDs in some embodiments can communicate via wired communication networks such as local area networks (“LANs”), the internet, the public telephone network, private telephone networks, or any other wired communication network. In some embodiments, CMDs may be capable of using more than one communication network and/or protocol.

In some embodiments, CMDs can communicate their location to the host computer system. The location (latitude and longitude coordinates) of a CMD can be determined by a technician who installs the CMD and records the coordinates at the device. For instance, a technician with a portable GPS locator could determine the coordinates of the location where he is installing the CMD and program those coordinates into the device. Alternatively, the technician or any other person could enter the street address into a geo-location device (or computer program), thereby determining the coordinates. In some embodiments, the CMD unit itself contains a GPS device and can thus calculate its location itself.

CMDs in some embodiments of the invention can detect the paging signal strength that is used to control the DCU. Thus, if the paging signal is weak or nonexistent at a particular CMD's location, the CMD can record that fact. The CMD can then communicate to the host computer system that the paging signal is inadequate at its location. A weak or nonexistent paging signal indicates to the host that the DCU at that particular location is incapable of curtailing electricity use because the DCU will never receive the page command signal to begin the curtailment.

In some embodiments, the CMDs periodically send “heartbeat” signals to the host computer system. These heartbeat signals enable the host to determine which CMDs are functioning properly. If the host fails to receive a heartbeat from a given CMD, this could be due to a failure of the CMD or a failure in the communication network between the host and the CMD. Either way, a lack of a heartbeat signal from a particular CMD indicates that the host is no longer receiving data updates from that particular CMD. Thus, the host does not have an up-to-date status of the DCU at that CMD's location. In some embodiments, the CMD can keep a log of the electric curtailment status of the DCUs it is monitoring. This log can be sent to the host when the communication network comes back up; thus, the host will not lose any historical data.

The timing of the heartbeat signals can be configured in some embodiments of the invention. In one embodiment, for instance, the heartbeat signal is configured to send a signal every ten minutes. If the host computer system does not receive a heartbeat from a given CMD in fifteen minutes, the host will classify that CMD as “idle” meaning that it has not reported within fifteen minutes. If the host computer system does not receive a heartbeat within twenty four hours, it will classify the CMD as “inactive” meaning that the CMD is presumed to be disabled. Such time increments can vary in different embodiments. In addition, certain embodiments can have more or fewer status gradations based on the elapsed time since the last heartbeat.

In some embodiments, the threshold voltages for determining whether an appliance has been curtailed can be adjusted or configured. For instance, a CMD monitoring a commercial air conditioning unit may have a threshold voltage of 1.5 volts for classifying whether electricity to the A/C unit has been curtailed. That is, if the CMD detects a voltage less than 1.5 volts, then the CMD classifies the attendant DCU as “curtailing”. Otherwise, the CMD classifies the DCU as “non-curtailing”. In another example, the voltage threshold for a swimming pool heater might be 0.8 volts.

After receiving data from the CMDs, the host computer system, in some embodiments can provide detailed analysis of the status of the various DCUs in the field. For instance, the host could generate a map illustrating the locations and statuses of the various DCUs. Different colors or symbols could be used to indicate whether a DCU was curtailing or non-curtailing or whether its attendant CMD was active, idle, or inactive. In some embodiments, a user can click on certain DCUs to drill-down into the data and learn more details such as a detailed history or actual voltage readings. In some embodiments, the data could be presented in tabular, graph, or network forms to aid in the understanding of the data.

In alternative embodiments of the invention, the CMDs could operate to report voltage levels at their respective appliances even if those appliances were not subject to control by a DCU. That is, the CMD devices could simply function as remote voltage meters to report the voltage read at their respective locations.

### BRIEF DESCRIPTION OF THE DRAWINGS

FIG. 1 is a block diagram of one embodiment of a system in accordance with the invention.

FIG. 1A is a block diagram of another embodiment of a system in accordance with the invention.

FIG. 2 is a block diagram of the physical components of a CMD in one embodiment of the invention.

FIG. 3 is a block diagram of the logical components of one embodiment of a CMD of the invention.

FIG. 4 is a block diagram of a host computer system in one embodiment of the invention.

FIG. 5 is a flow chart detailing the steps whereby the CMD monitors the voltage of an appliance.

FIG. 6 is a flow chart detailing the steps whereby the CMD monitors the signal strength of the paging network.

FIG. 7 is a flow chart detailing the steps whereby the CMD sends heartbeat information to the host computer system.

FIG. 8 is a flow chart detailing the steps whereby the host computer system processes communications from the individual CMDs.

### DETAILED DESCRIPTION

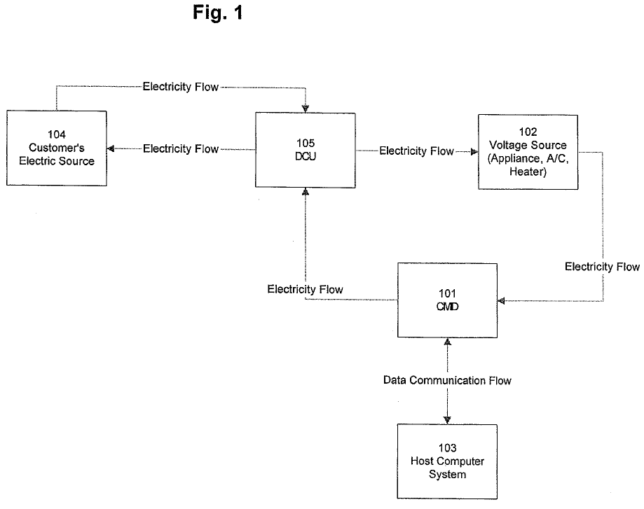

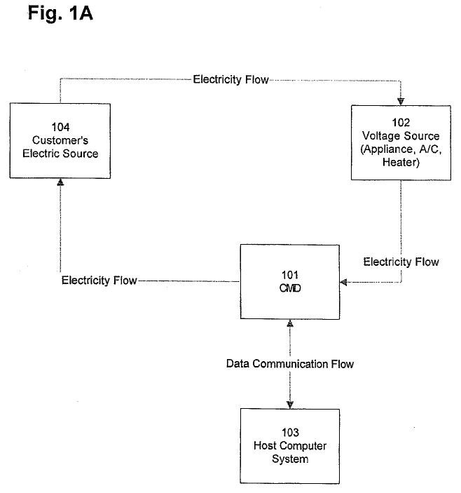

FIG. 1 is a block diagram of one embodiment of a system in accordance with the invention. A Curtailment Monitoring Device (CMD) 101 is connected to the customer's voltage source 102 and monitors the voltage at voltage source 102. The voltage source 102 could be any appliance that needed remote voltage monitoring such as an air conditioner, refrigerator, or electric pool heater. A Direct load Control Unit (DCU) 105 is also connected to the voltage source 102 and regulates the flow of electricity from the customer's electric source 104 to the voltage source 102. As described in more detail below, the DCU 105 can curtail the flow of electricity from the electric source 104 to the voltage source 102. A host computer system 103 can send communications to and receive communications from the CMD 101. As described in more detail below, the CMD 101 will communicate to the host computer system 103 whether the DCU 105 has curtailed electricity flow to the customer's voltage source 102.

FIG. 1A is a block diagram of another embodiment of a system in accordance with the invention. A CMD 101 is monitoring the voltage at the customer's voltage source 102 and reporting the voltage to a host computer system 103. In this embodiment, there is no DCU present to control the electricity flow to the customer's voltage source 102. Rather, the voltage source 102 is connected directly to the customer's electric source 104.

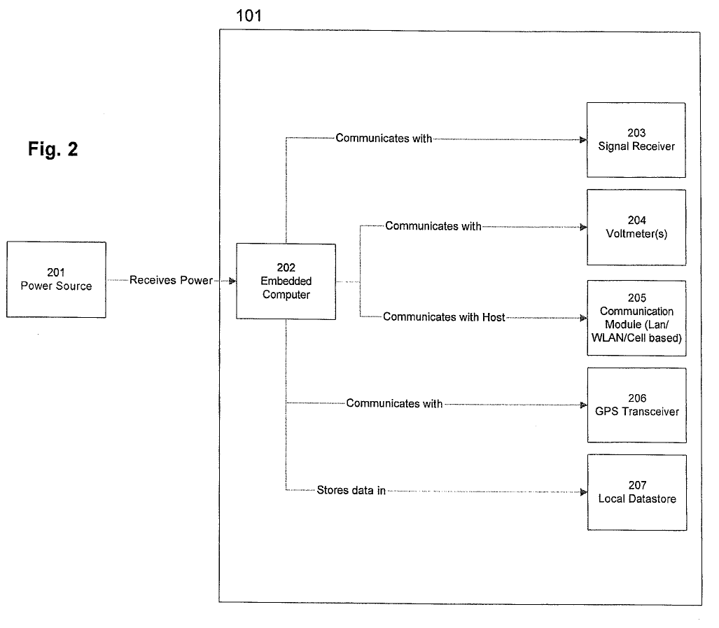

FIG. 2 is a block diagram of the physical components of a CMD 101 (FIGS. 1, 1A) in one embodiment of the invention. A power source 201 supplies electricity to the embedded computer 202 that is part of the CMD 101. The embedded computer 202 communicates with a signal receiver 203. The signal receiver 203 is capable of monitoring paging control signals that are sent over a paging network. This allows the CMD 101 to measure the relative strength or weakness of the paging control signals that control the co-located DCU 105 (FIG. 1).

The embedded computer 202 of the CMD 101 also communicates with a voltmeter 204. The voltmeter 204 monitors the voltage of the appliance/voltage source 102 (FIGS. 1, 1A) that the CMD 101 is monitoring. In this manner, the CMD 101 can determine if electricity to the appliance 102 has been curtailed by the DCU 105 (FIG. 1).

The CMD 101 contains a communications module 205 that is controlled by the embedded computer 202. The communications module 205 allows the CMD 101 to send messages to and receive messages from the host computer system 103 (FIGS. 1, 1A).

The CMD 101 contains a GPS transceiver 206 which allows the CMD to determine its latitude and longitude coordinates. The CMD 101 can transmit this information to the host computer system 103 (FIGS. 1, 1A).

The CMD 101 contains a local datastore 207 that allows the CMD 101 to store data. For instance, the CMD 101 can store historical heartbeat information for later transmission to the host computer system 103 (FIGS. 1, 1A). This storage capability is important if the communications link between the CMD 101 and the host computer system 103 is disrupted. The storage capability of the CMD 101 also gives added redundancy in case data is corrupted en route to the host computer system 103 or at the host computer system 103 itself.

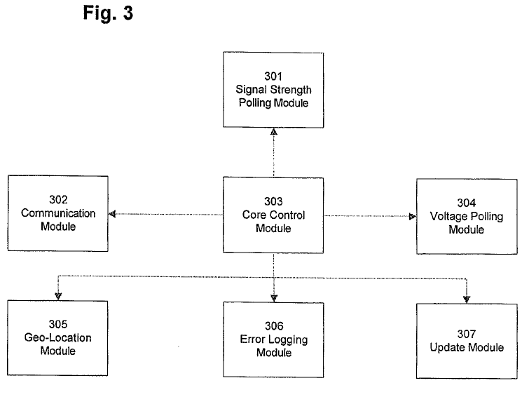

FIG. 3 is a block diagram of the logical components of one embodiment of a CMD 101 of the invention. The modules of FIG. 3 can be embodied in hardware or software or a combination of both. The CMD's embedded computer 202 (FIG. 2) will perform the logic described in the modules of FIG. 3.

Core control module 303 is the main control module that controls all the other modules of the CMD 101. As such, it communicates with all of the other modules of the CMD 101.

The signal strength polling module 301 contains logic to measure and respond to the strength or weakness of the control signal of the paging network. As such, the signal strength polling module 301 communicates with and controls the signal receiver 203 (FIG. 2).

The voltage polling module 304 contains logic to measure and respond to the voltage at the appliance 102 (FIGS. 1, 1A) being monitored by the CMD 101. The voltage polling module 304 communicates with and controls the voltmeter 204 (FIG. 2).

The logical communications module 302 contains logic to control the communications with the host computer system 103 (FIGS. 1, 1A). Such communications can be wired or wireless. The logical communications module 302 thus controls the physical communications module 205 (FIG. 2).

The geo-location module 305 contains logic to calculate the latitude and longitude of the CMD 101. The geo-location module 305 will communicate with and control the GPS transceiver 206 (FIG. 2).

The error logging module 306 contains logic to diagnose, repair, and/or report any errors encountered by the CMD 101. Such errors can be communicated to the host computer system 103 (FIGS. 1, 1A).

The update module 307 contains logic to allow the CMD 101 to download and install software updates from the host computer system 103 (FIGS. 1, 1A). For instance, if a software patch is needed to correct improper operations of the CMD 101, the update module 307 will perform the needed updates.

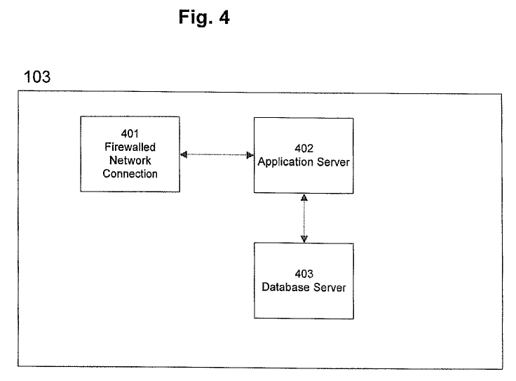

FIG. 4 is a block diagram of the host computer system 103 (FIGS. 1, 1A) in one embodiment of the invention. The host computer system 103 contains an application server 402, database server 403, and a firewalled network connection 401. The application server 402 contains application-level software for controlling the host computer system 103. The host computer system 103 stores data in the database server 403. The host computer system 103 communicates with the various CMDs 101 (FIGS. 1, 1A) via the firewalled network connection 401. As described earlier, such communications can be over wired or wireless networks.

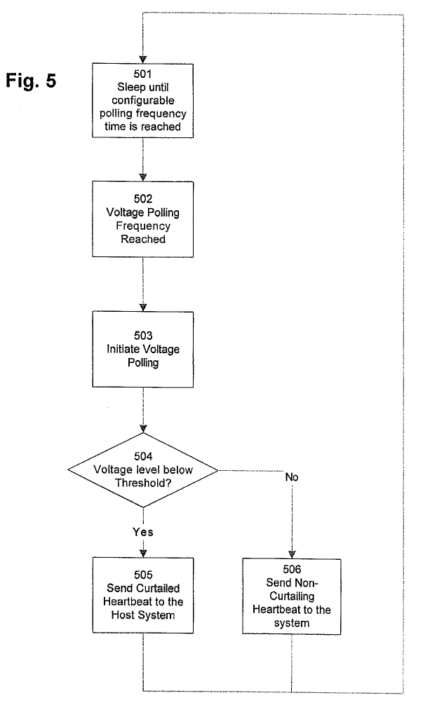

FIG. 5 is a flow chart outlining the steps whereby the voltage polling module 304 (FIG. 3) monitors the voltage of the customer's appliance/voltage source 102 (FIGS. 1, 1A).

At step 501, the voltage polling module 304 (FIG. 3) sleeps until the voltage polling frequency (“VPF”) is reached. The VPF can be configured in some embodiments of the invention. A default VPF might be every 10 minutes. That is, the voltage polling module 304 would check the voltage of the customer's appliance 102 every 10 minutes.

At step 502, the voltage polling module 304 is awakened after the VPF is reached.

At step 503, the voltage polling module 304 measures the voltage of the customer's appliance 102. The voltage polling module 304 reads the voltage measured by the voltmeter 204 (FIG. 2).

At step 504, the voltage polling module 304 determines whether the voltage measured at the customer's appliance 102 is greater than or less than a voltage threshold. The voltage threshold can be configured in some embodiments of the invention.

If the voltage measured in step 503 is above the voltage threshold, then the voltage polling module 304, at step 506, determines that the appliance 102 is in a “non-curtailing” state. This signifies that the appliance 102 is receiving its normal voltage and is not being curtailed by a DCU 105 or by any other means.

The voltage polling module 304 then communicates with the core control module 303 and/or the communications module 302. The communications module 302 then sends a heartbeat communication to the host computer system 103 indicating that the appliance 102 is in a non-curtailing state. The heartbeat communication also contains the exact voltage measured in step 503.

If the voltage measured in step 503 is below the voltage threshold, then the voltage polling module 304, at step 505, determines that the appliance 102 is in a “curtailing” state. This signifies that the appliance 102 is receiving less than its normal voltage and is actively being curtailed by a DCU 105 or by other means.

The voltage polling module 304 then communicates with the core control module 303 and/or the communications module 302. The communications module 302 then sends a heartbeat communication to the host computer system 103 indicating that the appliance 102 is in a curtailing state. The heartbeat communication also contains the exact voltage measured in step 503.

After sending a non-curtailing heartbeat in step 506 or a curtailing heartbeat in step 505, the voltage polling module 304 returns to step 501.

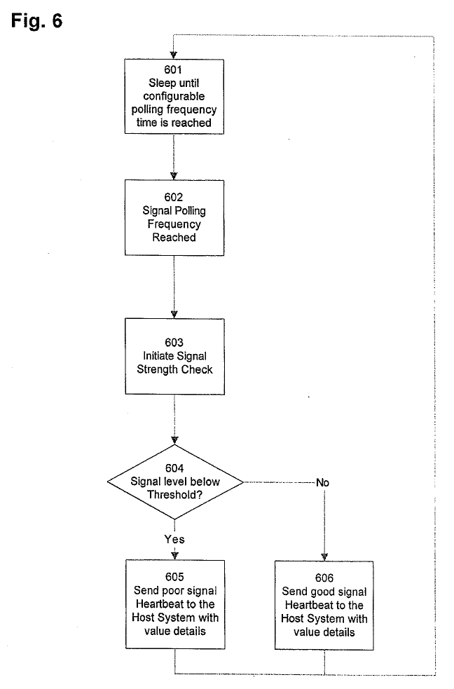

FIG. 6 is a flow chart outlining the steps whereby the signal strength polling module 301 (FIG. 3) monitors the strength or weakness of the control signal of the paging network. As described earlier, the paging network sends out control signals to control the DCUs 105 (FIG. 1). If the paging control signal is weak or nonexistent in a given location, then a DCU 105 in that location will not be able to receive the control signal and will therefore be unable to curtail electricity flow to the customer's appliance 102.

At step 601, the signal strength polling module 301 (FIG. 3) sleeps until the signal polling frequency (“SPF”) is reached. The SPF can be configured in some embodiments of the invention. In some embodiments, the SPF is the same as the VPF.

At step 602, the signal strength polling module 301 is awakened after the SPF is reached.

At step 603, the signal strength polling module 301 measures the strength of the control signal of the paging network. The control signal strength polling module 301 communicates with the signal receiver 203 (FIG. 2) to determine the strength of the paging control signal. As described earlier, the signal receiver 203 can directly measure the strength of the paging control signal.

At step 604, the signal strength polling module 301 determines whether the paging control signal strength measured by the signal receiver 203 is greater than or less than a control signal strength threshold. The control signal strength threshold can be configured in some embodiments of the invention.

If the signal strength measured in step 603 is above the control signal strength threshold, then the signal strength polling module 301, at step 606, determines that the paging control signal strength is adequate. This signifies that any DCU 105 at that location is capable of receiving a page control signal over the paging network and thus is able to begin curtailing electricity to the customer's appliance 102.

The signal strength polling module 301 then communicates with the core control module 303 and/or the communications module 302. The communications module 302 then sends a heartbeat communication to the host computer system 103 indicating that the paging control signal strength is adequate. In addition, the communications module 302 communicates the exact strength of the measured paging control signal.

If the signal strength measured in step 603 is below the signal strength threshold, then the signal strength polling module 301, at step 605, determines that the paging control signal strength is too weak. This signifies that any DCU 105 at that location is not capable of receiving a page control signal over the paging network and thus is not able to begin curtailing electricity to the customer's appliance 102.

The signal strength polling module 301 then communicates with the core control module 303 and/or the communications module 302. The communications module 302 then sends a heartbeat communication to the host computer system 103 indicating that the paging control signal strength is too weak to control the DCUs 105. In addition, the communications module 302 communicates the exact strength of the measured paging control signal.

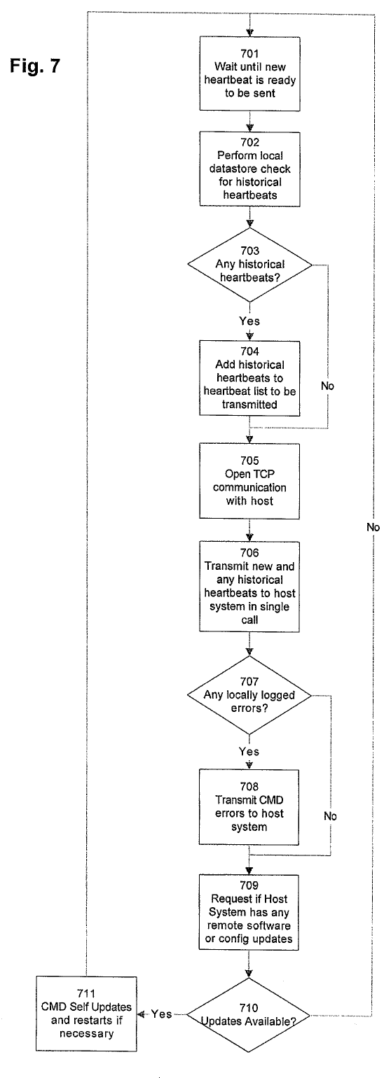

FIG. 7 is a flow chart of the detailed steps for sending a heartbeat from the CMD 101 (FIGS. 1, 1A) to the host computer system 103 (FIGS. 1, 1A). As described above in steps 505, 506, 605, and 606, the CMD 101 periodically sends heartbeat information to the host computer system 103 to communicate whether the appliance 102 is in a curtailing or non-curtailing state and whether the control signal strength of the paging network is adequate or not.

At step 701, the core control module 303 (FIG. 3) of the CMD 101 waits until a new heartbeat is ready to be sent.

At step 702, the core control module 303 performs a local datastore check to determine if there are any historical heartbeats that it has not yet sent to the host computer system 103. Such historical heartbeats may have been previously stored in the local datastore 207 (FIG. 2) if the communications network between the CMD 101 and the host computer system 103 was malfunctioning earlier. The CMD 101 records all heartbeat information in its local datastore 207 if the CMD 101 cannot transmit the heartbeat to the host computer system 103.

At step 703, the core control module 303 determines if there are any historical heartbeats that have not been sent to the host computer system 103. If so, the core control module 303, at step 704, adds the historical heartbeat information to the queue of data that is to be sent to the host computer system 103 during this communication session.

At step 705, the core control module 303 coordinates with the communications module 302 to open a TCP communication connection with the host computer system 103. The CMD 101 utilizes the communications hardware 205 present in the CMD 101 to transmit messages to and receive messages from the host computer system 103.

At step 706, the communications module 302 transmits all new and historical heartbeat data to the host computer system 103.

At step 707, the core control module 303 coordinates with the error logging module 306 to determine if there were any locally logged errors. If so, at step 708, the core control module 303 coordinates with the communications module 302 to transmit the error information to the host computer system 103.

At step 709, the CMD 101 sends a request to the host computer system 103 to determine if there are any software or configuration updates available. The CMD 101 evaluates the host computer system's 103 response at step 710.

If updates are available, the core control module 303 coordinates with the update module 307 to update the software and/or configuration files of the CMD 101 at step 711.

The CMD 101 then returns to step 701.

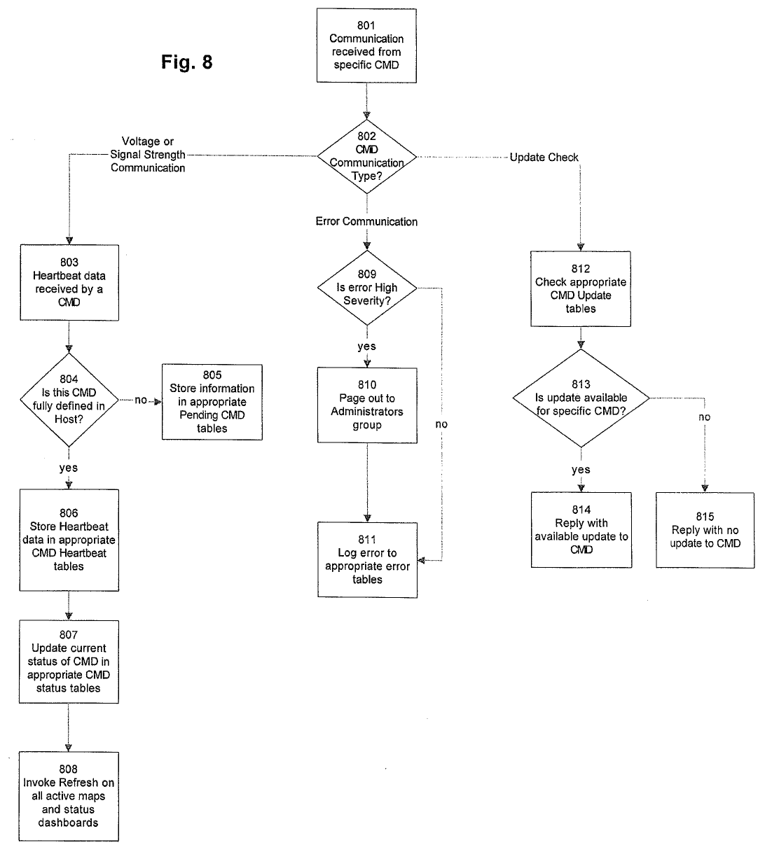

FIG. 8 is a flow chart of the detailed steps of how the host computer system 103 processes communications from the individual CMDs 101 (FIGS. 1, 1A).

At step 801, the host 103 receives a communication from a CMD101.

At step 802, the host 103 determines whether the communication is a voltage or signal strength heartbeat, an error message, or an update check for new software.

At step 803, the host 103 determines that the message received is a voltage or signal strength heartbeat.

At step 804, the host 103 queries the database 403 (FIG. 4) to determine if the host 103 has already encountered this particular CMD 101 before. If the host 103 has never encountered this CMD 101, then the host 103, at step 805, adds the CMD's 101 identification information to the table for “pending” CMDs in the host database 403.

At step 806, the host 103 stores the voltage and/or signal strength heartbeat data in the heartbeat table(s) in the host database 403.

At step 807, the host 103 updates the status of the CMD 101 in the status table(s) in the host database 403.

At step 808, the host 103 updates any maps, tables, dashboards, or other Graphical User Interface (“GUI”) elements that depend upon the updated tables.

If the host 103 receives an error communication, the host 103, at step 809, determines if the error communication is of high severity. If so, the host 103, at step 810, sends a page or other alarm to a group of administrators to alert them to the high severity error.

Regardless of the severity of the error, the host 103, at step 811, logs the error to the appropriate error table(s) in the database 403.

If the host 103 receives an update check communication, the host 103, at step 812, queries the database 403 to determine if there are any updates. At step 813, the host 103 evaluates the query results.

If updates are available, the host 103, at step 814, communicates with the CMD 101 that updates are available. If no updates are available, the host 103, at step 815, communicates with the CMD 101 that no updates are available.

Accordingly, while the invention has been described with reference to the structures and processes disclosed, it is not confined to the details set forth, but is intended to cover such modifications or changes as may fall within the scope of the following claims.

What is claimed is:

1. A method for monitoring a plurality of Direct load Control Units comprising the steps of:
a) periodically reading the voltage of an appliance associated with a Direct load Control Unit (“DCU”);
b) after each of said voltage readings, comparing said current voltage reading to a threshold voltage;
c) classifying said DCU as a first status if said current voltage reading is less than said threshold voltage;
d) classifying said DCU as a second status if said current voltage reading is greater than said threshold voltage; and
e) communicating the status of said DCU to a host computer system.

2. The method of claim 1 further comprising the step of communicating said current voltage reading to said host computer system.

3. The method of claim 1 wherein the periodicity of step (a) is configurable by a user.

4. The method of claim 1 wherein said threshold voltage is configurable by a user.

5. The method of claim 1 further comprising the step of communicating a latitude and longitude associated with said first DCU.

6. The method of claim 5 further comprising the step of displaying a map of a plurality of DCUs indicating their respective locations and statuses.

7. The method of claim 1 wherein said communication of step (e) occurs over a wired or wireless communications network.

8. The method of claim 1 further comprising the step of recording said communication in a persistent data storage device at said host computer system.

9. A method for monitoring a plurality of electrical appliances comprising the steps of:
a) periodically reading the voltage of an electrical appliance;
b) communicating after each of said voltage readings said current voltage reading to a host computer system; and
c) assigning a status to said electrical appliance based on said voltage reading.

10. The method of claim 9 wherein the periodicity of step (a) is configurable by a user.

11. The method of claim 9 further comprising the step of communicating a latitude and longitude associated with said electrical appliance.

12. The method of claim 11 further comprising the step of displaying a map of said plurality of electrical appliances indicating their respective locations and voltage readings.

13. The method of claim 9 wherein said communication of step (b) occurs over a wired or wireless communications network.

14. The method of claim 9 further comprising the step of recording said communication in a persistent data storage device at said host computer system.

15. A method for monitoring the strength of a control signal at a plurality of Direct load Control Units comprising the steps of:
a) periodically reading the strength of said control signal at a Direct load Control Unit (“DCU”); and
b) communicating said control signal strength reading to a host computer system.

16. The method of claim 15 wherein the periodicity of step (a) is configurable by a user.

17. The method of claim 15 further comprising the step of communicating a latitude and longitude associated with said DCU.

18. The method of claim 17 further comprising the step of displaying a map of said plurality of DCUs indicating their respective locations and the control signal strength at each of said DCUs.

19. The method of claim 15 wherein said communication of step (b) occurs over a wired or wireless communications network.

20. The method of claim 15 further comprising the step of recording said communication in a persistent data storage device at said host computer system.
